(19) United States
(12) Patent Application Publication
(10) Pub. No.: US 2017/0216132 A1
(43) Pub. Date: Aug. 3, 2017

(54) Thermal Massaging Device

(71) Applicant: FIRE AND ICE THERAPY, LLC, La Jolla, CA (US)

(72) Inventors: Charles Johnson, San Diego, CA (US); Rodrigo Iglesias, San Diego, CA (US); Luke Seed, San Diego, CA (US)

(21) Appl. No.: 15/417,891

(22) Filed: Jan. 27, 2017

Related U.S. Application Data
(60) Provisional application No. 62/288,345, filed on Jan. 28, 2016.

(51) Int. Cl. A61H 15/00

(52) U.S. Cl. CPC A61H 15/0092; A61H 2201/10; A61H 2201/0207; A61H 2201/0214

(57) ABSTRACT

Generally disclosed is a massaging device that is capable of applying a thermal or cooling massage to an area or portion of a body, for example, the back, legs, arms, muscles, ligaments, tendons, and fascia.

### CROSS-REFERENCE TO RELATED APPLICATIONS

This application claims the benefit and priority of U.S. Provisional Application No. 62/288,345 filed on Jan. 28, 2016, entitled “Thermal Messaging Device.”

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND AN INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

Field of Invention

The disclosed subject matter is in the field of massaging devices and physical therapy.

Background of the Invention

For rehabilitation and physical therapy, heat therapy and cold therapy are common methods to aid in the recovery of sore muscles. Heat therapy can increase blood flow to an area, decrease joint stiffness, and relieve or reduce pain. Cold therapy helps reduce swelling and inflammation to aid in recovery and rehabilitation. In addition to hot and cold therapy, foam rolling therapy is also used to help rehabilitate a muscle because foam rolling has massage-like effects and can produce a myofascial release, which helps speed up recovery of tight or sore muscles. Foam rolling can also be beneficial because it allows a user to conveniently massage his or her own muscles without the assistance of another individual.

However, it can be difficult or inconvenient to apply hot or cold therapy while rolling because applying a heat or ice pack in between rolling periods can be tedious, applying or strapping heat or ice packs to certain areas of the body can be difficult, and rolling while heat or ice packs are applied can be uncomfortable. Therefore, a need exists that allows a user to roll or massage a muscle with a device that can safely emit hot or cold temperatures, so that a user experiences the benefit of hot or cold therapy while rolling a muscle. Accordingly, the current invention combines the benefits of hot or cold therapy and massage rolling.

### SUMMARY OF THE INVENTION

In view of the foregoing, an object of this invention is to provide a rolling massaging device that allows a user to heat or cool down the surface of the massaging device to benefit from hot or cold therapy while massaging a muscle.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1a is a top down view of a massaging device according to an exemplary embodiment.

FIG. 1b is a top down view of a massaging device according to an exemplary embodiment.

FIG. 1c is a top down view of a massaging device according to an exemplary embodiment.

FIG. 1d is a side view of a massaging device according to an exemplary embodiment.

FIG. 1e is a side view of a massaging device according to an exemplary embodiment.

FIG. 1f is a perspective view of a massaging device according to an exemplary embodiment.

FIG. 1g is a side view of a massaging device according to an exemplary embodiment.

FIG. 1h is a bottom up view of a massaging device according to an exemplary embodiment.

FIG. 2a is an exploded view of a massaging member according to an exemplary embodiment.

FIG. 2b is an exploded view of a massaging member according to an exemplary embodiment.

FIG. 2c is a perspective view of a massaging member according to an exemplary embodiment.

FIG. 3a is a top down view of a first cap according to an exemplary embodiment.

FIG. 3b is a top down view of a first cap according to an exemplary embodiment.

FIG. 4a is a top down view of a second cap according to an exemplary embodiment.

FIG. 4b is a top down view of a second cap according to an exemplary embodiment.

FIG. 5a is a perspective view of components of a massaging member according to an exemplary embodiment.

FIG. 5b is a perspective view of a massaging member according to an exemplary embodiment.

FIG. 6 is a perspective view of components of a massaging member according to an exemplary embodiment.

FIG. 7 is a perspective view of components of a massaging member according to an exemplary embodiment.

FIG. 8 is a perspective view of components of a massaging member according to an exemplary embodiment.

FIG. 9 is a perspective view of a massaging member in use according to an exemplary embodiment.

FIG. 10 is a side view of a massaging member according to an exemplary embodiment.

FIG. 11 is an exploded view of a massaging member according to an exemplary embodiment.

FIG. 12 is a side view of a massaging member according to an exemplary embodiment.

FIG. 13 is a perspective view of a first fitting according to an exemplary embodiment.

FIG. 14 is a perspective view of a second fitting according to an exemplary embodiment.

FIG. 15 is a perspective view of a first cap according to an exemplary embodiment.

FIG. 16 is a perspective view of a second cap according to an exemplary embodiment.

FIG. 17 is an exploded view of a massaging member according to an exemplary embodiment.

FIG. 18 is a perspective view of a massaging member according to an exemplary embodiment.

FIG. 19 is a perspective view of a massaging member with a sleeve covering the massaging member.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

In the following detailed description, reference is made to the accompanying drawings which form a part hereof and in which is shown by way of illustration specific embodiments in which the invention may be practiced. These embodiments are described in sufficient detail to enable those skilled in the art to practice the invention, and it is to be understood that other embodiments may be utilized and that structural or logical changes may be made without departing from the scope of the present invention.

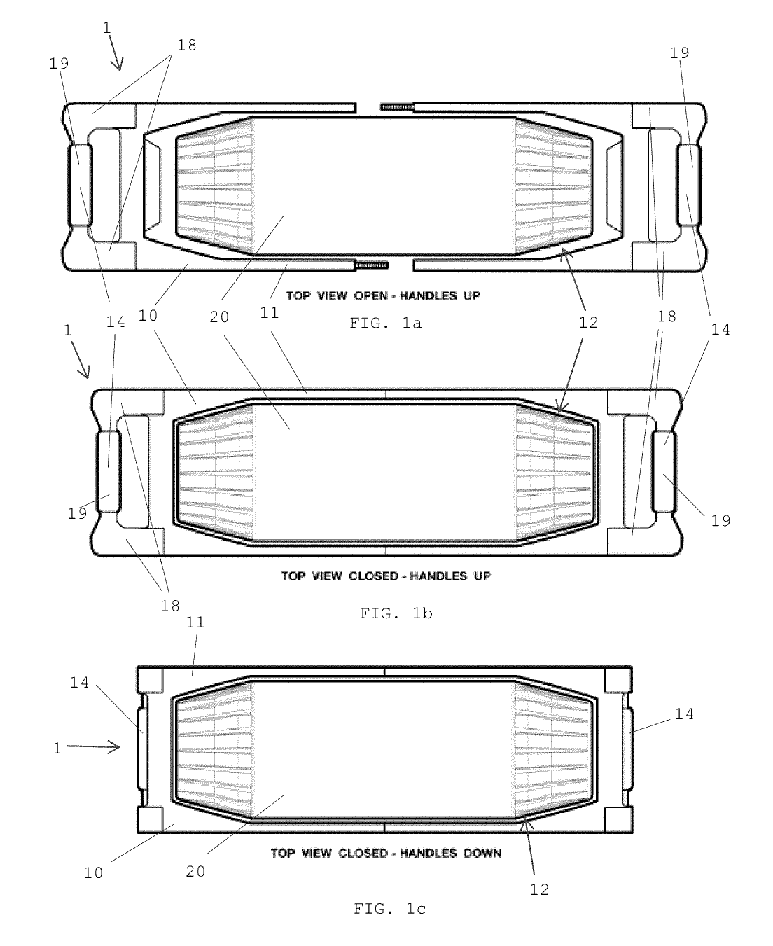

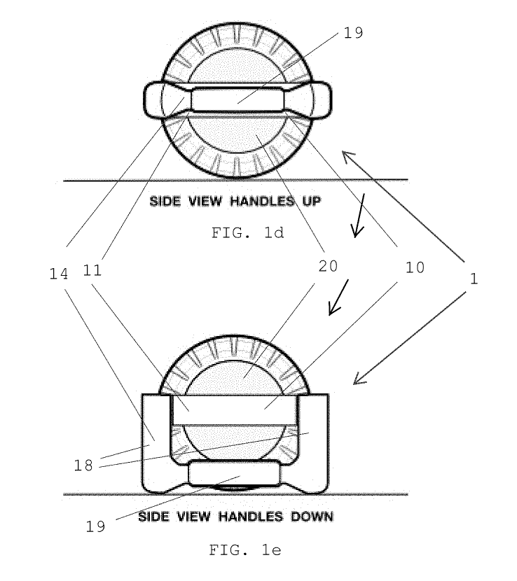

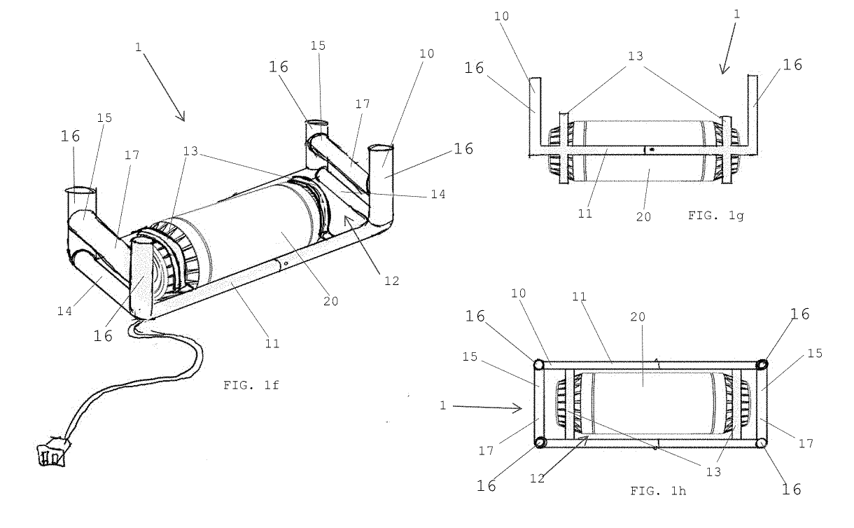

The following detailed description is, therefore, not to be taken in a limiting sense, and the scope of the present invention is defined by the appended claims. The present disclosure pertains to a massaging device 1 capable of applying a thermal massage to an area or portion of a body, for example, the back, legs, arms, muscles, ligaments, tendons, fascia, or the like. In one embodiment, the massaging device 1 can be a massaging member 20. In one embodiment, as shown in FIGS. 1a-1h, the massaging device 1 can have a stabilization system 10 and a massaging member 20.

The stabilization system 10 allows the massaging member 20 to remain in place when the massaging device 1 is in use. In one embodiment, the stabilization system 10 prevents the massaging member 20 from rolling along a surface. In one embodiment, the stabilization system 10 elevates the massaging member 20 above a surface. In one embodiment, the stabilization system 10 allows for the massaging member 20 to spin in place. The stabilization system 10 can rotationally engage the massaging member 20. In one embodiment, the stabilization system 10 can have a frame 11. The frame 11 can have multiple sides defining the perimeter of a hole 12 for receiving the massaging member 20. The frame 11 can engage or rotationally engage the massaging member 20. The frame 11 can rotationally engage the ends of the massaging member 20, for example, at the caps 200 and/or 300. The frame 11 can receive and/or stabilize the massaging member 20.

In one embodiment, the stabilization system 10 can have brackets 13 for stabilizing the massaging member 20. The brackets 13 can be rigid thereby supporting the massaging member. The brackets 13 allow for the massaging member to rotationally engage the stabilization system 10. The brackets 13 can engage at least one side of the frame 11. The brackets 13 can be circular in shape defining a loop for receiving the massaging member 20, thereby allowing the massaging member 20 to rotate therein.

In one embodiment, the stabilization system 10 has a support system 15. In one embodiment, the frame 11 engages the support system 15. The support system 15 allows the user to support his/her body in a raised position while using the massaging member 20. The support system 15 can have risers 16 for raising the user, massaging member 20, and or support members 17 in a vertical direction. In one embodiment, the risers 16 engage the frame 11 and the support members 17 engage the risers 16. While a riser 16 can engage the frame 11 at any location on the frame 11, a riser 16 preferably engages the frame 11 at the corner of the frame 11 and can extend vertically from the frame 11. The support member 17 can be positioned horizontally between two risers 16 thereby engaging one riser 16 at one end of the support member 17 and engaging another riser 16 at another end of the support member 17. The support member 17 allows for the user to support the body of the user above the massaging member 20. The support member 17 can be used as a handle for grasping the stabilization system 10.

In one embodiment, the stabilization system 10 can have a handle 14 for grasping the stabilization system 10. In one embodiment, the handle 14 allows the user to support the body of the user above the massaging member 20. The handle 14 can engage the frame 11. In one embodiment, the handle 14 rotationally engages the frame 11 thereby allowing for the handle 14 to rotate from a first substantially horizontal or in-line position to a second substantially vertical or perpendicular position with relation to the frame 11, as shown in FIGS. 1a-1e. The handle 14 can rotationally engage the frame by any means of rotationally engaging two members, for example, without limitation, a hinge, a living hinge, a swivel hinge, or the like. The handle 14 can have extenders 18 and grasping members 19. The extenders 18 raise the user and/or massaging member 20 in a vertical direction. In one embodiment, the extenders 18 engage the frame 11 and the grasping members 19 engage the extenders 18. The grasping member 19 can be positioned horizontally between two extenders 18 thereby engaging one extender 18 at one end of the grasping member 19 and engaging another extender 18 at another end of the grasping member 19. The grasping member 19 allows for the user to support the body of the user above the massaging member 20.

When the handle 14 is in the first horizontal position, the handle 14 allows the user to grasp the massaging device 1 and roll the massaging device 1 up and down a portion of the user's body or a portion of another person's body.

When the handle 14 is in the second vertical position, the handle 14 allows the massaging member 20 to remain in place when the massaging device 1 is in use. In one embodiment, the handle 14 prevents the massaging member 20 from rolling along a surface. In one embodiment, the stabilization system 10 elevates the massaging member 20 above a surface. In one embodiment, the stabilization system 10 allows for the massaging member 20 to spin in place.

In one embodiment, the stabilization system 10 can have a heating system 9 for heating the massaging member 20. The heating system 9 can heat the frame 11 and/or the support system 15. The heating system 9 can have any mechanism for heating metal pipes, for example, without limitation, a heating element incorporated in or engaged to the frame 11 and/or the support system 15.

The size of the stabilization system 10, frame 11, handles 14, massaging device 20, grasping member 19, and other elements of the invention can vary in height, width, length, diameter, etc.

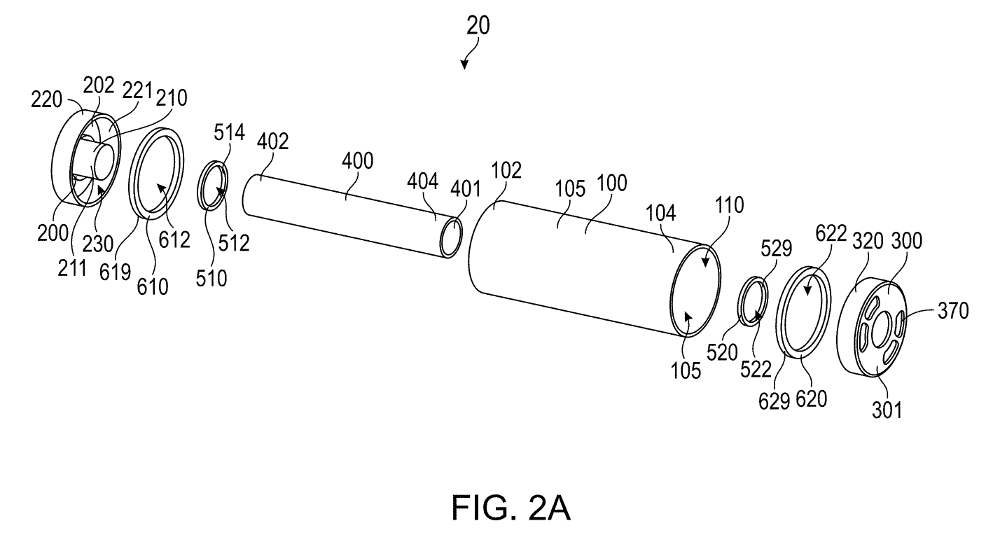

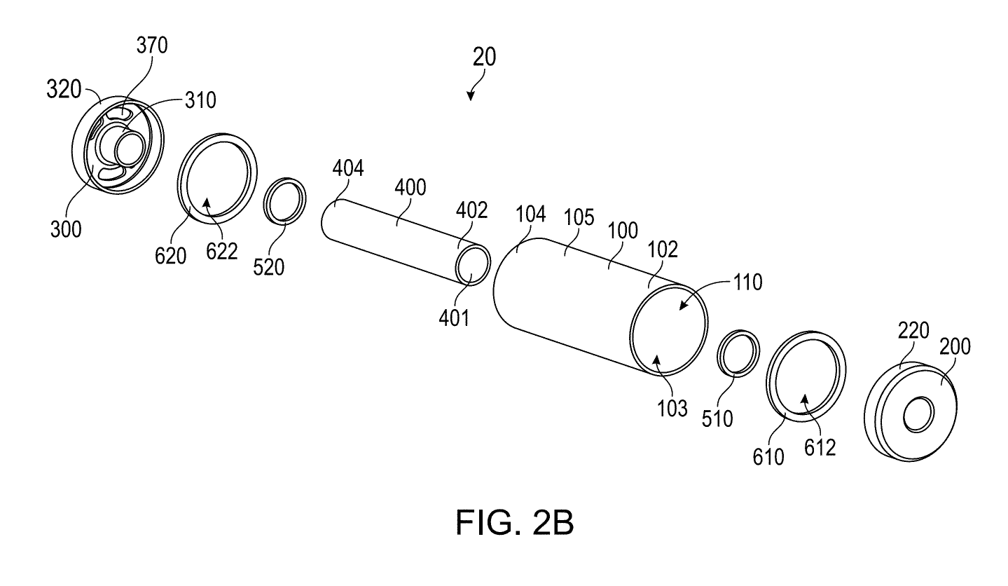

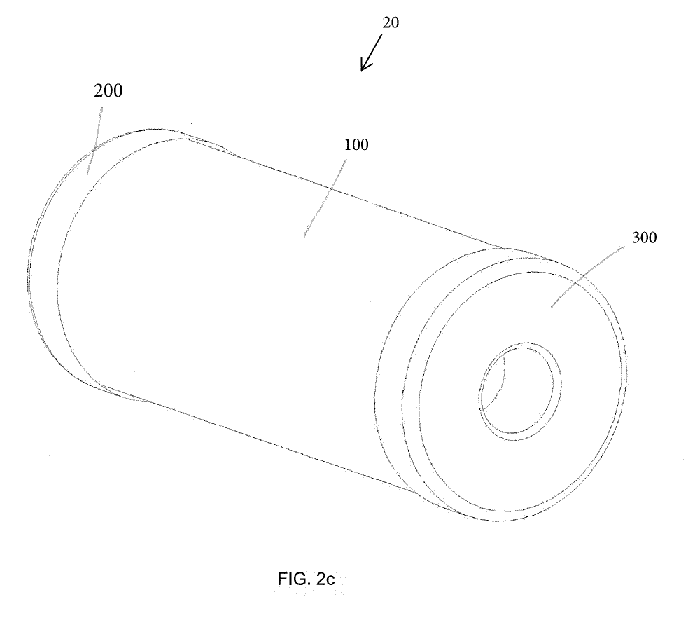

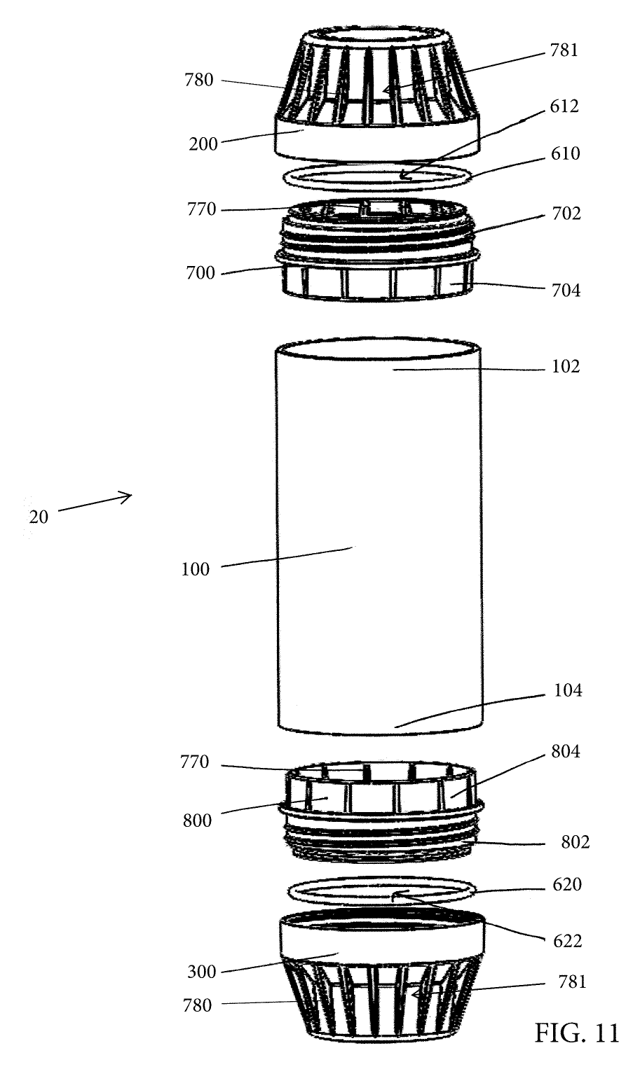

As shown in FIGS. 2a-2c and 10-12, the massaging member 20 can have an outer body 100 and a first cap 200, and a heat transfer medium 30. The massaging member 20 can be any shape suitable for massaging a portion of a body, for example, without limitation, cylindrical, spherical, rod-shaped, star-shaped, or the like.

The outer body 100 can be firm. The rigidity of the outer body 100 resists deforming under the weight of the user. In one embodiment, the outer body 100 can be firm and supple for providing cushioned support to the user. The outer body 100 maintains its shape during use, allowing it to roll over the body part, section, or portion of the user to be massaged. In one embodiment, the outer body 100 is both ridged to resist deforming under the weight of the user and soft to cushion the user from the discomfort that would result from the rigidity of the outer body 100 against the user. The outer body 100 can be made of any thermal conductive material that allows for thermal energy transfer from the heat transfer medium 30 to the exterior of the outer body 100, for example, aluminum, steel, or the like, while maintaining the rigid integrity of the outer body 100. In one embodiment, the exterior surface of the outer body 100 can be undulated, rippled, or the like, having depressions, indentations, knobs, bumps, ridges, or the like.

In one embodiment, the outer body 100 can be heated or cooled to allow for thermal energy to be transfer between outer body 100 and a portion of the body of the user, specifically, the thermal energy can transfer from the outer body 100 to the body portion or from the body portion to the outer body 100 depending on whether the user desires a hot or cold temperature to be applied to the section of the body by the massaging member 20. For example, where the user desires to heat a section of the body, the outer body 100 can be heated allowing for thermal energy to transfer from the outer body to the body portion, thereby heating the portion of the body. By way of another example, where the user desires to cool a section of the body, the outer body 100 can be cooled allowing for thermal energy to transfer from the body portion to the outer body 100, thereby cooling the portion of the body. The outer body 100 can be heated by any means in which to heat a member similar to the outer body 100, for example, without limitation, the outer body 100 can be heated utilizing microwaves, water, air, electricity, or the like. The outer body 100 can be cooled by any means in which to cool a member similar to the outer body 100, for example, without limitation, the outer body 100 can be cooled utilizing water, air, electricity, or the like.

As shown in FIGS. 2a and 2b, the outer body 100 can have at least one passageway 110 for receiving heat transfer medium 30. The outer body 100 can have a first end 102 with a first opening 103 and a second end 104 with a second opening 105. The outer body 100 can be of any shape suitable for massaging a portion of a body, for example, without limitation, cylindrical, spherical, rod-shaped, star-shaped, or the like.

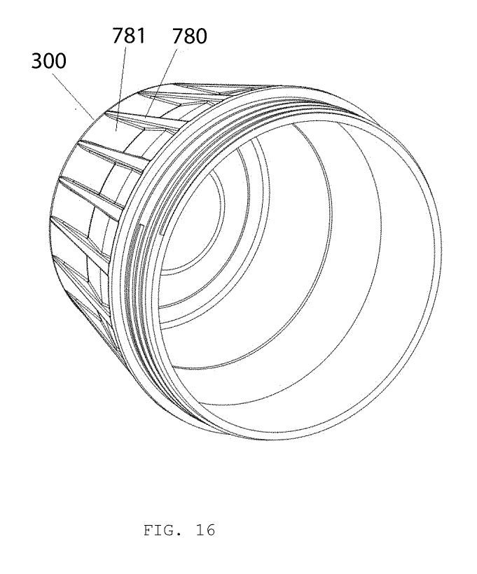

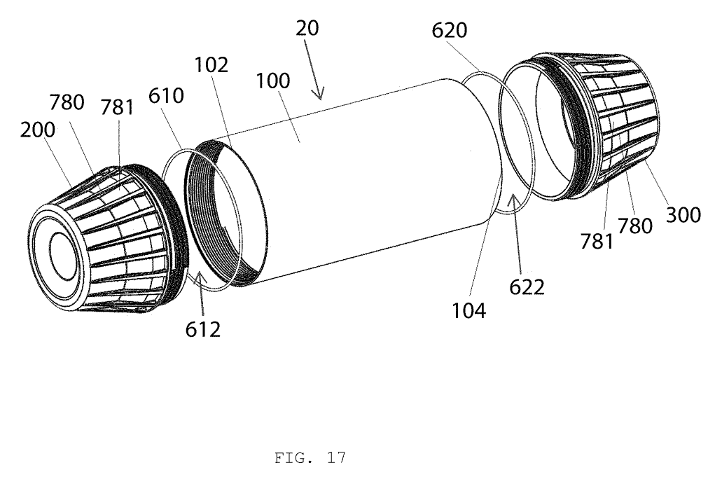

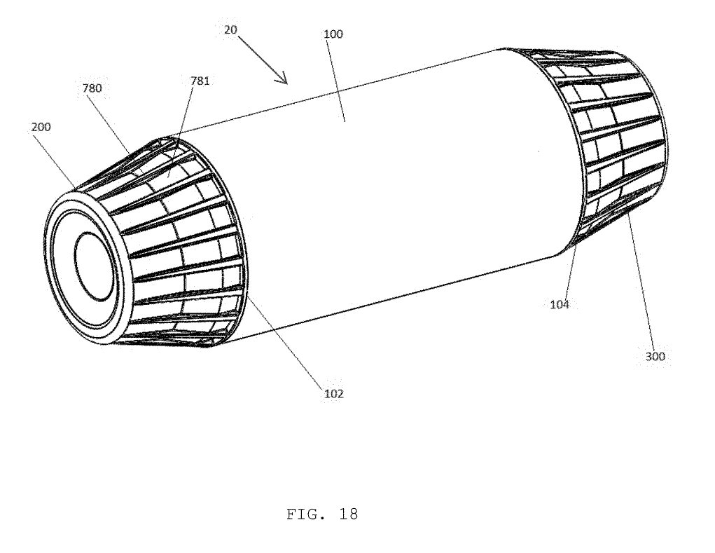

In one embodiment, as shown in FIGS. 2a-8, and 10-18, the massaging member 20 can have a first cap 200 and/or a second cap 300. The first cap 200 or second cap 300 operatively engage the first end 102 or second end 104 of the outer body 100. In one embodiment, the first end 102 and/or the second end 104 have threads for engaging the first cap 200 or second cap 300. The first cap 200 and second cap 300 can threadably engage the threads on the outer body 100. Threads can be positioned on the exterior or the interior of the outer body 100 and/or positioned on the exterior or the interior of the first cap 200 and second cap 300.

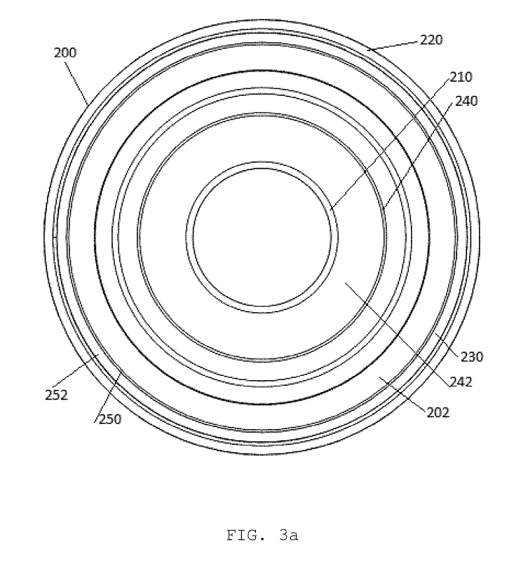

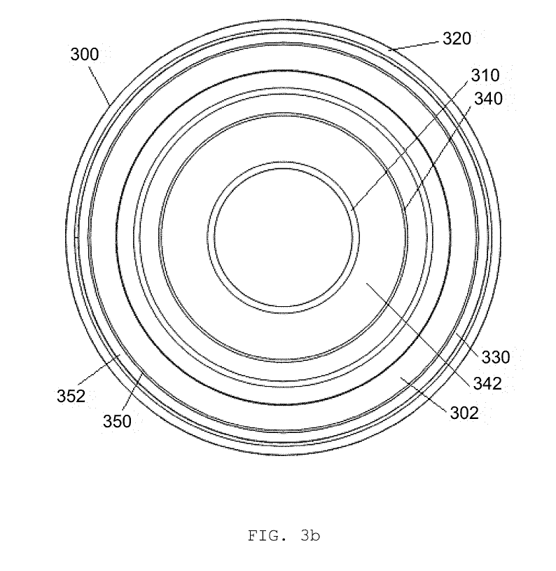

In one embodiment, as shown in FIGS. 3a and 3b, the first cap 200 can have a first exterior body collar 220 extending from the periphery of the interior surface 202 of the first cap 200 where the first cap 200 and first exterior body collar 220 define a first cap cavity 230 capable of receiving the first end 102 of the outer body 100. The first exterior body collar 220 is sized in a manner where upon the first exterior body collar 220 receiving the outer body 100, the interior surface 221 of the first exterior body collar 220 is mated to the exterior surface of the outer body 100.

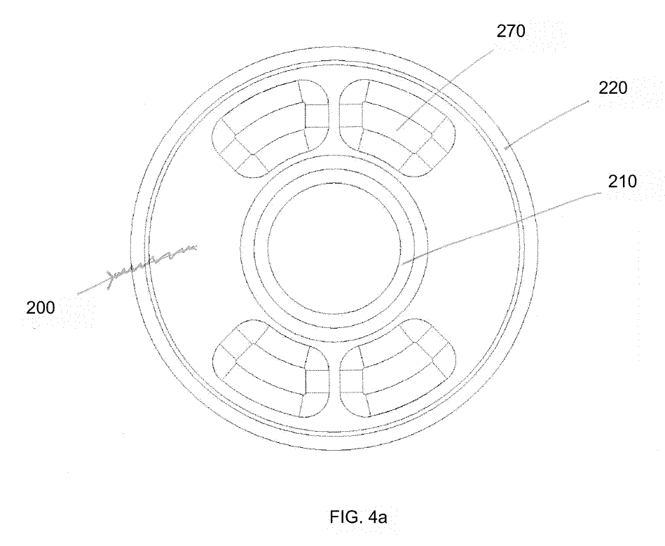

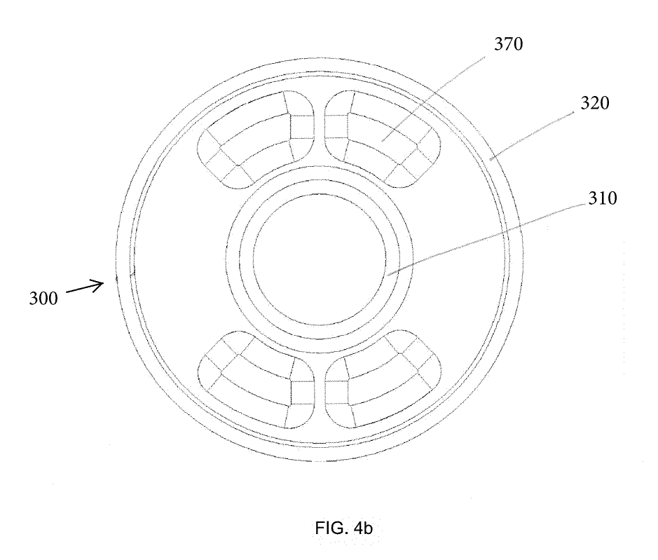

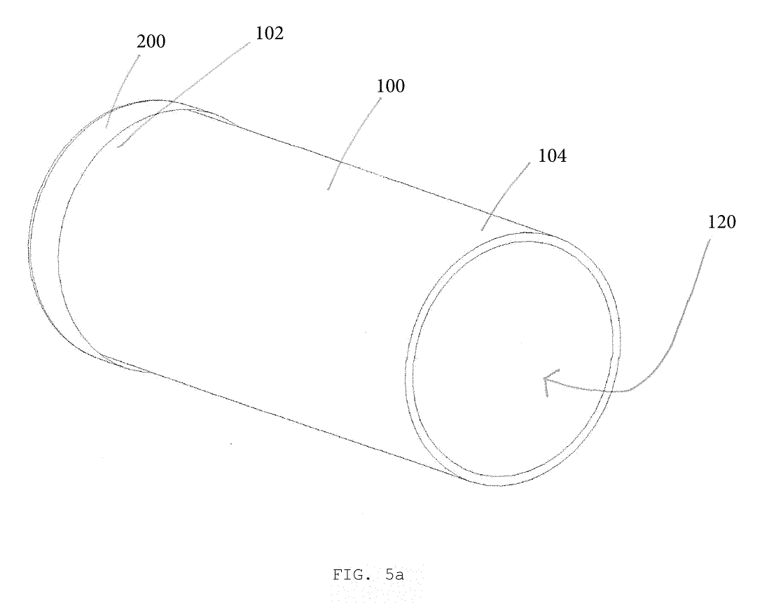

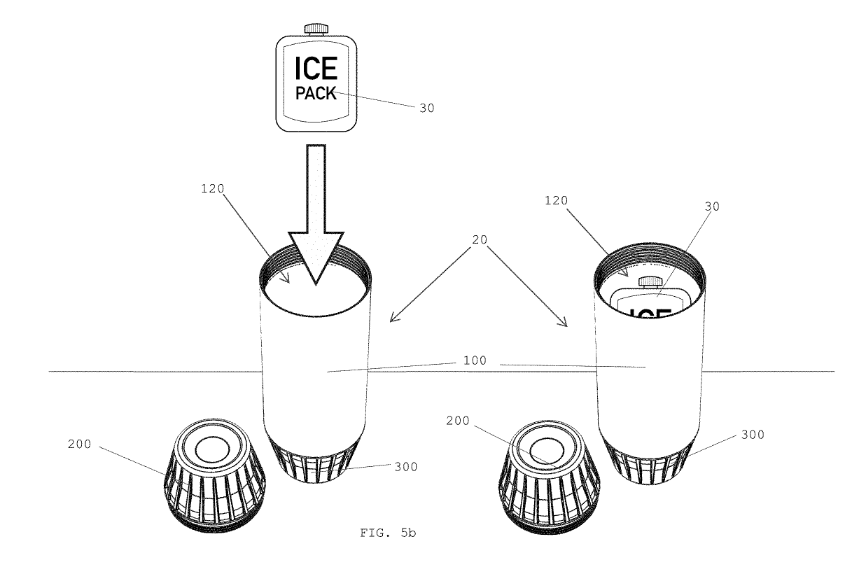

In one embodiment, as shown in FIGS. 4a and 4b, the second cap 300 can have a second exterior body collar 320 extending from the periphery of the interior surface 302 of the second cap 300 where the second cap 300 and second exterior body collar 320 define a second cap cavity 330 capable of receiving the second end 104 of the outer body 100. The second exterior body collar 320 is sized in a manner where upon the second exterior body collar 320 receiving the outer body 100, the interior surface 321 of the second exterior body collar 320 is mated to the exterior surface 105 of the outer body 100.

Threads can be positioned on the exterior and/or the interior of the first exterior body collar 220 and second exterior body collar 320. As shown in FIG. 5a, upon the first cap 200 or second cap 300 engaging the first end 102 or second end 104 of the outer body 100, a main cavity 120 is defined.

In one embodiment, the first cap 200 and/or second cap 300 have indentions 370 incorporated into the exterior surface of the first cap 200 and/or second cap 300 thereby allowing the user to grip, or apply a greater rotational force to, the first cap 200 and/or second cap 300 when engaging the first cap 200 and/or second cap 300 to the outer body 100 and/or to aid the user while threadably engaging or disengaging the first cap 200 and/or second cap 300 from the outer body 100. As shown in FIG. 5b, the main cavity 120 is capable of receiving heat transfer medium 30, for example, hot or cold water, hot or cold thermal gel packs, or the like. Thermal energy can transfer between the interior of the main cavity 120 to the exterior of the outer body 100, specifically, the heat transfer medium 30 can transfer thermal energy from the interior of the main cavity 120 to the exterior of the outer body 100 or from the exterior of the outer body 100 to the interior of the main cavity 120 depending on whether the user desires a hot or cold temperature to be applied to the section of the body by the massaging member 20. For example, where the user desires to heat a section of the body, heat transfer medium 30 with a hot temperature can be added to the main cavity 120 allowing for thermal energy to transfer from the main cavity 120 to the exterior of the outer body 100, thereby heating the section of the body. By way of another example, where the user desires to cool a section of the body, heat transfer medium 30 with a cold temperature is added to the main cavity 120 allowing for thermal energy to transfer from the exterior of the outer body 100 to the main cavity 120, thereby cooling the section of the body.

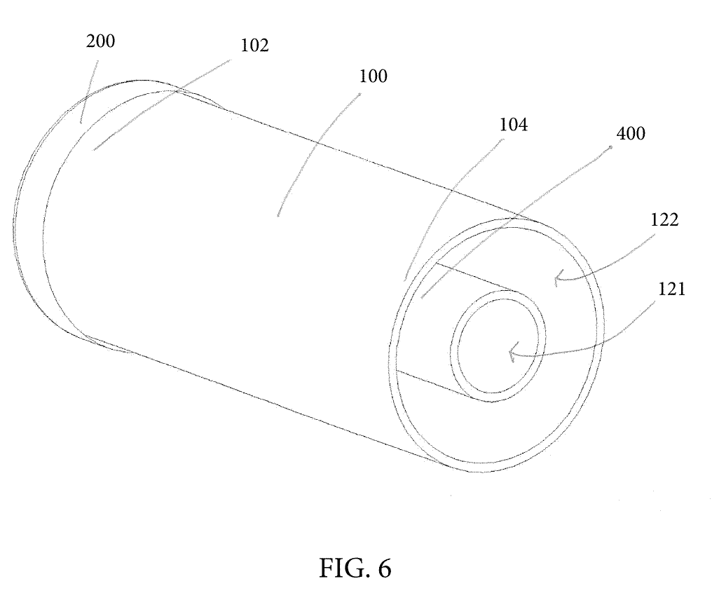

In one embodiment, the massaging member 20 can have a divider 400 for separating the main cavity 120 into at least two cavities. The divider 400 can be any shape that allows for the creation of at least two cavities within the main cavity 120. In the preferred embodiment, as shown in FIG. 6, by way of example, the divider 400 has a cylindrical shape where the cylindrically shaped divider 400 is capable of dividing the main cavity 120 by defining a core cavity 121 located in the interior of the divider 400 and an inner cavity 122 located between the outer body 100 and the cylindrical divider 400. In this embodiment, the divider 400 allows for a decreased volume of the heat transfer medium 30 to be used allowing for a lighter and thus more easily maneuverable massaging member 20. For example, the heat transfer medium 30 is added to the inner cavity 122 allowing for the core cavity 121 to remain void of heat transfer medium 30, thereby decreasing the volume of the heat transfer medium 30 added to the massaging member 20 and thus decreasing the weight of the massaging member 20. Thermal energy can transfer between the heat transfer medium 30 in the inner cavity 122 and the exterior of the outer body 100.

In one embodiment, the divider 400 can be a plate or flat member (not shown) that defines a first cavity and a second cavity. While the divider 400 can separate the first cavity and second cavity into any shape and/or volume, including a semicircle, or the like, the divider 400 preferably bisects the main cavity 120 thereby defining a first cavity and second cavity with a substantially similar shape and volume. The first cavity and second cavity can receive heat transfer medium 30. The first cavity can receive heat transfer medium 30 with a first temperature and the second cavity can receive heat transfer medium 30 with a second temperature allowing a user to alternate between temperatures utilizing one massaging member 20. For example, the heat transfer medium 30 in the first cavity can have a cold temperature and the heat transfer medium 30 in the second cavity can have a hot temperature.

The divider 400 can be made of insulating material, for example, plastic, or the like, thereby decreasing the amount of thermal energy transfer between the multiple cavities within the main cavity 120. For example, where the divider 400 has a cylindrical shape defining a core cavity 121 and an inner cavity 122, the insulating material of the divider 400 decreases the thermal energy transfer between the heat transfer medium 30 in the inner cavity 122 and the core cavity 121.

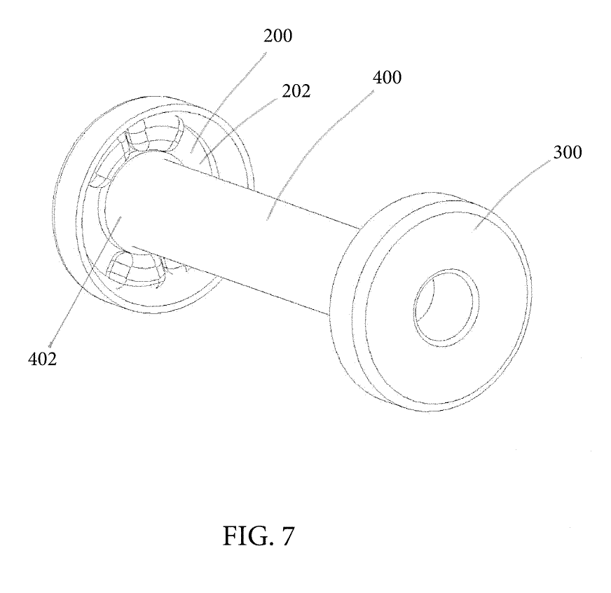

In one embodiment, as shown in FIG. 7 by way of example, the divider 400 engages the first cap 200. For example, the first end 402 of the divider 400 engages the interior surface 202 of the first cap 200. In one embodiment, the divider 400 releaseably engages the first cap 200. The divider 400 can releaseably engage the first cap 200 by the core cavity 121 at the first end 402 receiving the first protrusion 210. The core cavity 121 is sized in a manner where upon the first end 402 of the core cavity 121 receiving the first protrusion 210, the interior surface 401 of the divider 400 is mated to the exterior surface 211 of the first protrusion 210.

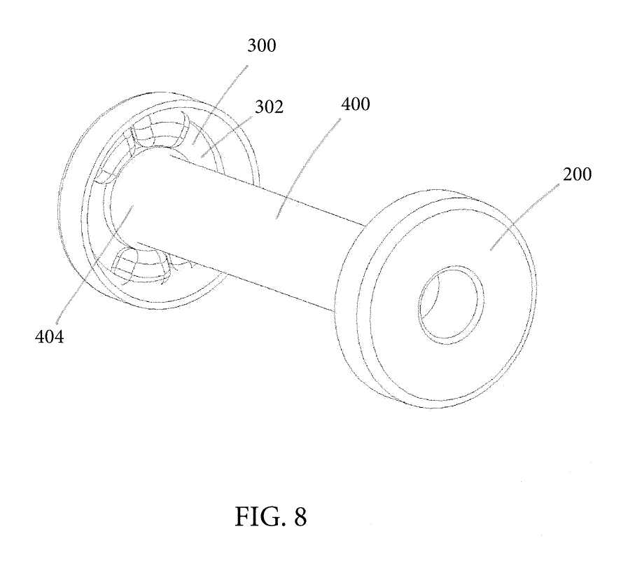

In one embodiment, as shown in FIG. 8 by way of example, the divider 400 engages the second cap 300. For example, the second end 404 of the divider 400 engages the interior surface 302 of the second cap 300. In one embodiment, the divider 400 releaseably engages the second cap 300. The divider 400 can releaseably engage the second cap 300 by the core cavity 121 at the second end 404 receiving the second protrusion 310. The core cavity 121 is sized in a manner where upon the second end 404 of the core cavity 121 receiving the second protrusion 310, the interior surface (401 of the divider 400 is mated to the exterior surface 311 of the second protrusion 310.

In one embodiment, the massaging member 20 can have a first divider seal 510 for preventing heat transfer medium 30 from seeping between the first end 402 of the divider 400 and the interior surface 202 of the first cap 200. The first divider seal 510 can be positioned between the first end 402 of the divider 400 and the interior surface 202 of the first cap 200. In one embodiment, a first divider channel 242 receives the first divider seal 510. The interior diameter of the first divider seal 510 is substantially similar to the exterior diameter of the first protrusion 210, where upon the opening 512 of the first divider seal 510 receiving the first protrusion 210, the interior surface 514 of the first divider seal 510 is mated to the exterior surface 211 of the first protrusion 210.

In one embodiment, the massaging member 20 can have a second divider seal 520 for preventing heat transfer medium 30 from seeping between the second end 404 of the divider 400 and the interior surface 302 of the second cap 300. The second divider seal 520 can be positioned between the second end 404 of the divider 400 and the interior surface 302 of the second cap 300. In one embodiment, a second divider channel 342 receives the second divider seal 520. The interior diameter of the second divider seal 520 is substantially similar to the exterior diameter of the second protrusion 310 where upon the opening 522 of the second divider seal 520 receiving the second protrusion 310, the interior surface 524 of the second divider seal 520 is mated to the exterior surface 311 of the second protrusion 310.

In one embodiment, the first cap 200 can have a first divider collar 240 protruding from the interior surface 202 of the first cap 200. The first divider collar 240 defines a first divider channel 242 capable of receiving a first divider seal 510. In one embodiment, the second cap 300 can have a second divider collar 340 protruding from the interior surface of the second cap 300. The second divider collar 340 defines a second divider channel 342 capable of receiving a second divider seal 520.

In one embodiment, the massaging member 20 can have a first body seal 610 having an opening 612, where the first body seal 610 is capable of preventing heat transfer medium 30 from seeping between the first end 102 of the outer body 100 and the first cap 200 or between the first fitting 700 and the first cap 200. In one embodiment, as shown in FIGS. 2a-2b, the first body seal 610 can be positioned between the first end 102 of the outer body 100 and the interior surface 202 of the first cap 200. In one embodiment, a first body channel 252 receives the first body seal 610. The first body seal 610 is sized in a manner where upon the first cap 200 receiving the first body seal 610 and the first cap 200 engaging the first end 102 of the outer body 100, first body seal 610 is mated to the interior surface 221 of the first exterior body collar 220 of the first cap 200, thereby preventing heat transfer medium 30 from seeping between the first end 102 of the outer body 100 and the first cap 200.

In one embodiment, the massaging member 20 can have a second body seal 620 having an opening 622, where the second body seal 620 is capable of preventing heat transfer medium 30 from seeping between the second end 104 of the outer body 100 and the second cap 300 or between the second fitting 800 and the second cap 300. In one embodiment, as shown in FIGS. 2a-2b, the second body seal 620 can be positioned between the second end 104 of the outer body 100 and the interior surface 302 of the second cap 300. In one embodiment, a second body channel 352 receives the second body seal 620. The second body seal 620 is sized in a manner where upon the second cap 300 receiving the second body seal 620 and the second cap 300 engaging the second end 104 of the outer body 100, the second body seal 620 is mated to the interior surface 321 of the second exterior body collar 320 of the second cap 300, thereby preventing heat transfer medium 30 from seeping between the second end 104 of the outer body 100 and the second cap 300.

In one embodiment, the first cap 200 can have a first interior body collar 250 extending from the interior surface 202 of the first cap 200 where the first interior body collar 250 defines a first body channel 252 capable of receiving a first body seal 610. In one embodiment, second cap 300 can have a second interior body collar 350 extending from the interior surface 302 of the second cap 300 where the second interior body collar 350 defines a second body channel 352 capable of receiving a second body seal 620.

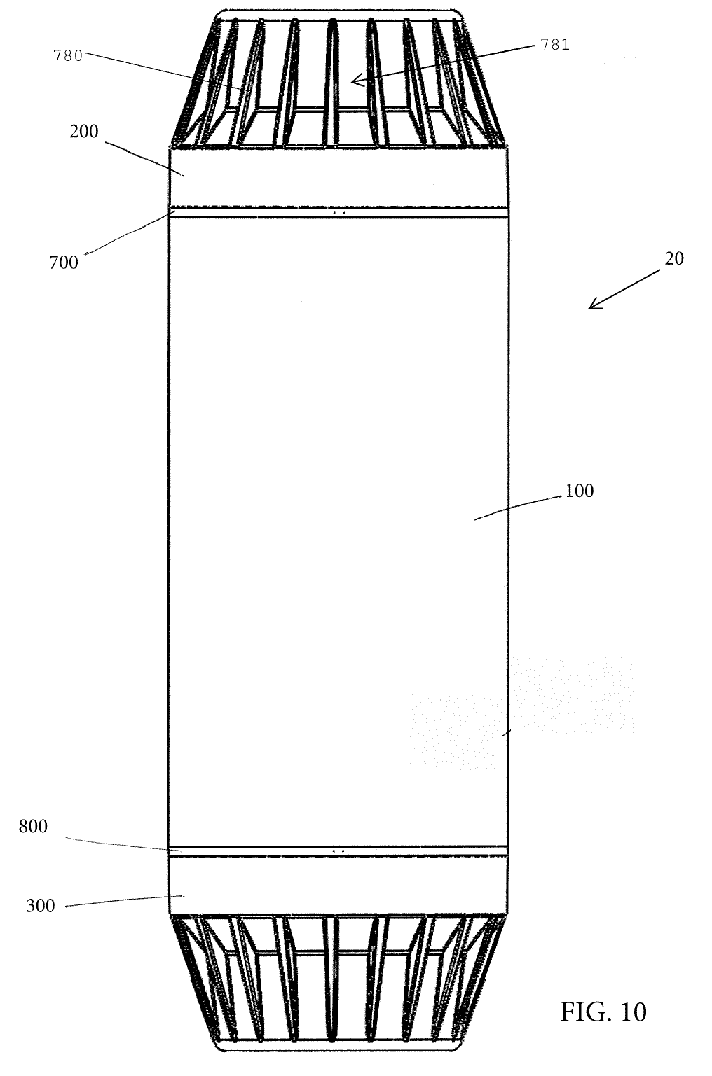

In one embodiment, as shown in FIGS. 10-12, the massaging member 20 can have a first fitting 700 and/or second fitting 800. The first fitting 700 and second fitting 800 can be any type of tube fitting, for example, without limitation, a coupler, adapter, reducer, cap, or the like. For exemplar purposes, this disclosure will describe a messaging member 20 utilizing a fitting, however, although the disclosure describes this and other exemplary embodiments, other embodiments are possible, and changes may be made to the embodiments described without departing from the spirit and scope of the invention.

In one embodiment, as shown in FIG. 13, the first fitting 700 can have a tubular shape defining a passageway 710, a first end 702, and a second end 704. The first fitting 700 can engage the first cap 200. In one embodiment, the first end 702 of the first fitting 700 is capable of engaging the first cap 200. The first end 702 can engage the first cap 200 by any means in which a fitting engages a tube, for example, without limitation, by way of, male and female connectors, threading, adhesion, friction fit, snap fit, or the like. In one embodiment, the first end 702 releaseably engages the first cap 200. In one embodiment, the first end 702 can threadably engage the first cap 200. At the first end 702, the exterior of the first fitting 700 has a threaded section, for example, without limitation, a male member with a threaded exterior for threadably engaging with a female member with a threaded interior of the first cap 200.

The first fitting 700 can engage the outer body 100. In one embodiment, the second end 704 of the first fitting 700 is capable of engaging the outer body 100. The second end 704 can engage the outer body 100 by any means in which a fitting engages a tube, for example, without limitation, by way of, male and female connectors, threading, adhesion, or the like. In one embodiment, the second end 704 of the exterior of the first fitting 700 has a male member for engaging with a first end 102 (female member) of the outer body 100. Here, the male member of the second end 704 of the first fitting 700 can be pressed into the female member of the first end 102 of the outer body 100. The second end 704 and first end 102 can be secured with threading, adhesion, welding, soldering, brazing, cementing, or the like.

In one embodiment, as shown in FIGS. 10-12, the first body seal 610 can be positioned between the first end 702 of the first fitting 700 and the first cap 200. In one embodiment, a first body channel 252 receives the first body seal 610 and/or the opening 612 receives the first end 702. The first body seal 610 is sized in a manner where upon the first cap 200 receiving the first body seal 610 and the first cap 200 engaging the first end 702 of the first fitting 700, the first body seal 610 is pressed between the first cap 200 and the first fitting 700, thereby preventing heat transfer medium 30 from seeping between the first end 702 of the first fitting 700 and the first cap 200.

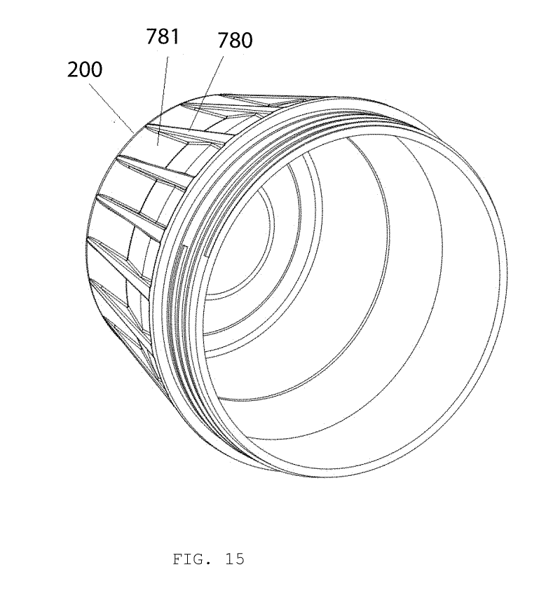

In one embodiment, as shown in FIG. 14, the second fitting 800 can have a tubular shape defining a passageway 610, a first end 802, and a second end 804. The second fitting 800 can engage the second cap 300. In one embodiment, the first end 802 of the second fitting 800 is capable of engaging the second cap 300. The first end 802 can engage the second cap 300 by any means in which a fitting engages a tube, for example, without limitation, by way of, male and female connectors, threading, adhesion, or the like. In one embodiment, the first end 802 releaseably engages the second cap 300. In one embodiment, the first end 802 can threadably engage the second cap 300. At the first end 802, the exterior of the second fitting 800 has a threaded section, for example, without limitation, a male member with a threaded exterior for threadably engaging with a female member with a threaded interior of the second cap 300.

The second fitting 800 can engage the outer body 100. In one embodiment, the second end 804 of the second fitting 800 is capable of engaging the outer body 100. The second end 804 can engage the outer body 100 by any means in which a fitting engages a tube, for example, without limitation, by way of, male and female connectors, threading, adhesion, or the like. In one embodiment, the second end 804 of the exterior of the second fitting 800 has a male member for engaging with a second end 104 (female member) of the outer body 100. Here, the male member of the second end 804 of the second fitting 800 can be pressed into the female member of the second end 104 of the outer body 100. The second end 804 and second end 104 can be secured with threading, adhesion, welding, soldering, brazing, cementing, or the like.

In one embodiment, as shown in FIGS. 10-12, the second body seal 620 can be positioned between the first end 802 of the second fitting 800 and the second cap 300. In one embodiment, a second body channel 352 receives the second body seal 620 and/or the opening 622 receives the first end 802. The second body seal 620 is sized in a manner where upon the second cap 300 receiving the second body seal 620 and the second cap 300 engaging the first end 802 of the second fitting 800, the second body seal 620 is pressed between the second cap 300 and the second fitting 800, thereby preventing heat transfer medium 30 from seeping between the first end 802 of the second fitting 800 and the second cap 300.

The first and/or second body seal 610, 620 can be made of any suitable soft elastic or semi-rigid material such as thermoplastic materials or curable elastomeric materials that allow for the first and/or second body seal 610, 620 to be compressed. The term “elastomer” refers generally to a polymeric material that has rubberlike properties. More specifically, most elastomers have a significant amount of resilience or the ability to recover from an elastic deformation. Examples of elastomers include, without limitation, natural rubbers, polyisoprene, styrene butadiene rubber, chloroprene rubber, polybutadiene, nitrile rubber, butyl rubber, ethylene propylene rubber, ethylene propylene diene monomer, chlorosulfonated polyethylene, polysulfide rubber, polyurethane, and silicones.

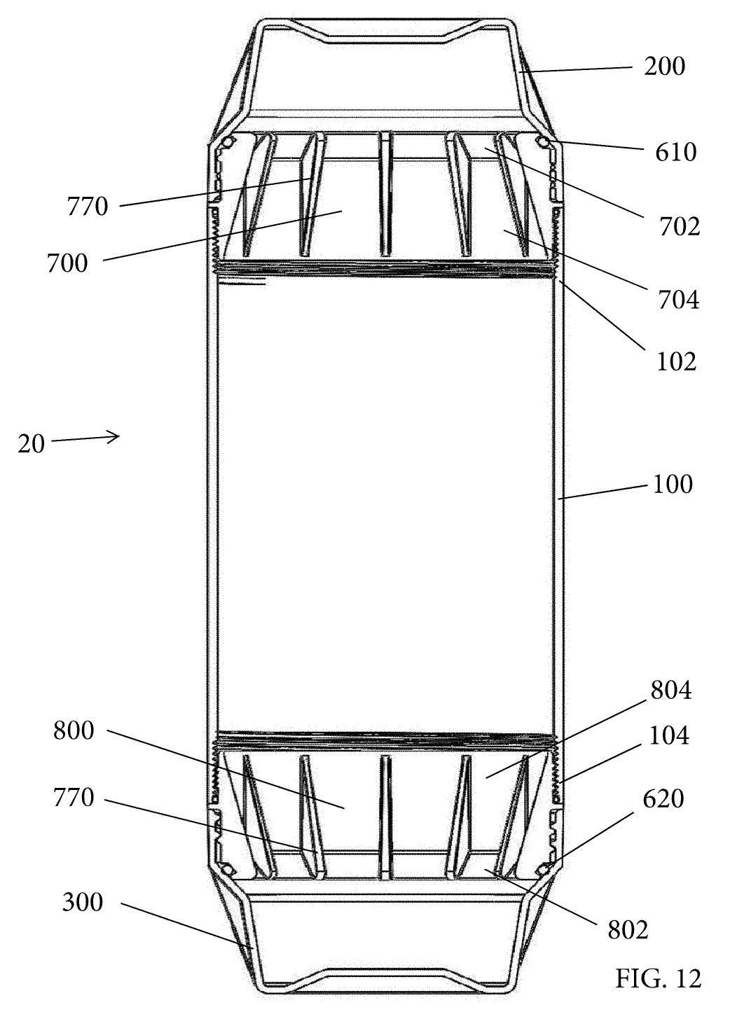

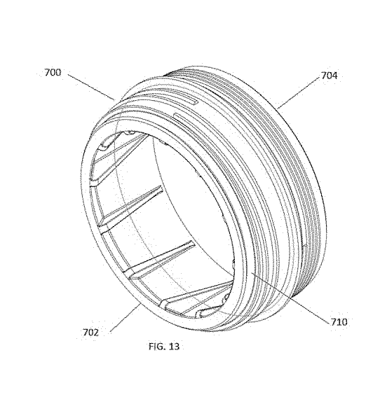

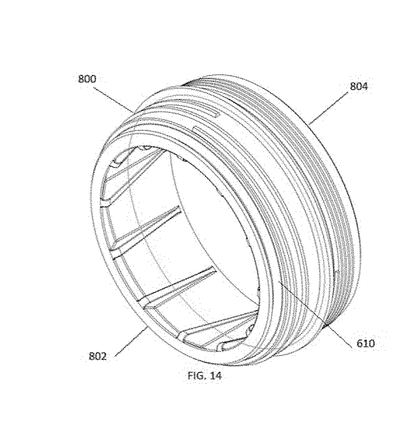

In one embodiment, as shown in FIGS. 12-14, the first and second fitting 700, 800 can have support members 770 for providing support or resilience to the first and second fitting 700, 800. Upon the first and second fitting 700, 800 engaging with the first and second cap 200, 300 and/or the outer body 100, a force can be applied to the first and second fitting 700, 800 which can cause the first and second fitting 700, 800 to collapse, bend, break, deform, or the like. The support members 770 can resist this force allowing for the integrity of the original shape or form of the first and second fitting 700, 800 to be maintained. The support members 770 can engage the interior surface of the first and second fitting 700, 800.

In one embodiment, as shown in FIGS. 10, 11, 15-18, the first and second cap 200, 300 can have support members 780. The support members 780 can allow the user to more easily grip the first and second cap 200, 300. The support members 780 can provide support or resilience to the first and second cap 200, 300. Upon the first and second cap 200, 300 engaging with the first and second fitting 700, 800, a force can be applied to the first and second cap 200, 300 which can cause the first and second cap 200, 300 to collapse, bend, break, deform, or the like. The support members 780 can resist this force allowing for the integrity of the original shape or form of the first and second cap 200, 300 to be maintained. The support members 780 can engage the exterior surface of the first and second cap 200, 300.

In one embodiment, as shown in FIGS. 10, 11, 15-18, the first and second cap 200, 300 can have indentations 781. The indentations 781 can allow the user to more easily grip the first and second cap 200, 300.

In one embodiment, the massaging member 20 can have a connecting member (not shown). The connecting member can allow for the massaging member 20 to have two outer bodies 100 whereby one outer body 100 is used to transfer thermal energy from the outer body 100 to the body portion and another outer body 100 is used to transfer thermal energy from the body portion to the outer body 100. In one embodiment, the connecting member operatively engages a first outer body 100 and second outer body 100. The connecting member can have threads for engaging the first and second outer bodies 100. Threads can be positioned on the exterior or the interior of the connecting member. By way of example, the following describes one method of using the massaging device 1. The second cap 300 can be disengaged from the outer body 100 and divider 400 exposing the core cavity 121 and the inner cavity 122. Heat transfer medium 30 with a cold temperature is added to the inner cavity 122 and the second cap 300 is reengaged to the outer body 100 and divider 400, thereby sealing the heat transfer medium 30 within the inner cavity 122. The user can then rest the desired body portion to be massaged on the massaging member 20 and roll the massaging member 20 on the ground thereby receiving a massage due to the force the body applies to the massaging member 20. For example, where the desired body portion to be massaged is the hamstring, the massaging member 20 is placed on the ground. The user sits in an upright position on top of the device resting the hamstring of the user on the device with a raised buttocks off the ground supported by the hands and arms of the user supporting the user on one end and the massaging member 20 supporting the user on the other end. The user can push or pull with the arms causing the massaging member 20 to roll up and down the hamstring of the user. The rolling movement kneads the muscles which promotes circulation and myofascial release. The device also affects joints and ligaments as it rolls back and forth on the muscle, bringing relief via application of pressure. Thermal energy from the heat transfer medium 30 is transferred through the outer body 100 towards the portion of the hamstring touching the outer body 100. In one embodiment, the thermal energy transferred from the outer body 100 to the hamstring increases the temperature of the hamstring (passive warm-up), thereby providing additional circulation, relaxation, or the like to the hamstring. In one embodiment, the thermal energy transferred from the hamstring to the outer body 100 decreases the temperature of the hamstring thereby decreasing swelling, inflammation, or the like.

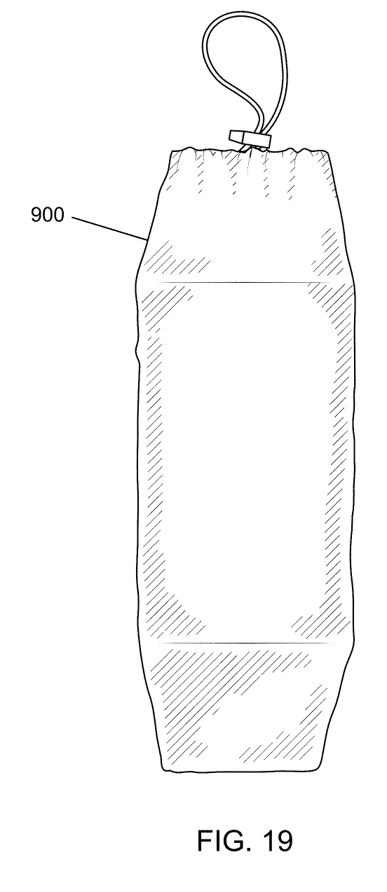

FIG. 19 is a perspective view of the massaging device with a sleeve covering the massaging member. Referring to FIG. 19, in one embodiment, the present disclosure pertains to a sleeve 900 for protecting the skin of the user when the massaging member 20 is hot and/or cold. In one embodiment, the massaging member 20 can have the sleeve 900. In one embodiment, the sleeve 900 has mesh holes thereby allowing for heat to transfer through the holes. In one embodiment, the sleeve 900 can have a drawstring incorporated into the sleeve 900 for preventing the sleeve 900 from traversing the massaging member 20. In one embodiment, the sleeve 900 can be made of elastic material for preventing the sleeve 900 from traversing the massaging member 20. The sleeve 900 can be sized so that the cross-sectional diameter of the sleeve 900 is less than the cross-sectional diameter of the massaging member 20. The elastic material of the sleeve 900 can be stretched beyond the distance of the vertical cross-sectional diameter of the massaging member 20 allowing for the sleeve 900 to contract around the massaging member 20 when the massaging member 20 is inserted into the sleeve 900. In one embodiment, the sleeve 900 can be made of material that can absorb condensation, for example, condensation that forms around the exterior surface of the massaging member 20, thereby increasing the friction of the surface of the massaging member 20. In one embodiment, the sleeve 900 can be made of material that prevents scratches or damage to the exterior of the massaging member 20. In one embodiment, the sleeve 900 can be made of material that reduces the amount of thermal energy transferred from the outer body 100 to the body portion.

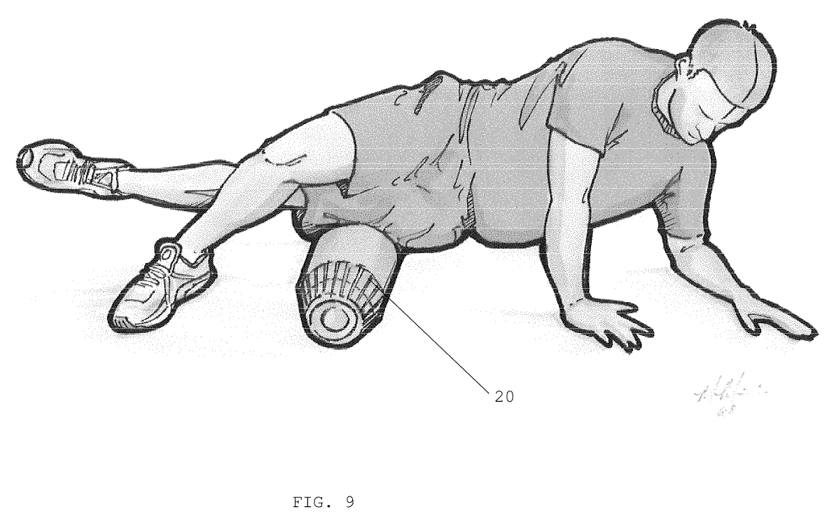

By way of another example, the following describes one method of using the massaging device 1. The first cap 200 can be disengaged from the first fitting 700 exposing the main cavity 120. Heat transfer medium 30 with a hot temperature is added to the main cavity 120 and the first cap 200 is reengaged to the first fitting 700, thereby sealing the heat transfer medium 30 within the main cavity 120. The user can then rest the desired body portion to be massaged on the massaging member 20 and roll the massaging member 20 on the ground thereby receiving a massage. For example, as shown in FIG. 9, where the desired body portion to be massaged is the leg, the massaging member 20 is placed on the ground. The user rests the leg on top of the device. The user can traverse the leg across the massaging member 20 causing the massaging member 20 to roll up and down the leg of the user. In one embodiment, the thermal energy transferred to the leg from the outer body 100 increases the temperature of the leg thereby increasing circulation, relieving tension, or the like.

In yet another embodiment, the massaging device 20 may be a massaging stick that can be thermally heated or cooled down, wherein the massaging device 20 is small in diameter (i.e., two inches in diameter) and features a first and second cap 200, 300 that are approximately the same diameter as the massaging device 20. In one embodiment, the first and second cap may suitable to be used as handles or, in another embodiment, handles may be located at the ends of the massaging device 20, wherein the massaging device 20 rotates within the handles.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. A massaging device comprising:
a body with a securing mechanism on at least one end, wherein the body consists of a thermal conductive material; and,
at least one cap that is engaged into the securing mechanism of said at least one end;
whereby a user can experience a hot or cold massage on a muscle by rolling the muscle over the body of the massaging device.

2. The massaging device of claim 1, further defined by a first seal that is located at the base of the securing mechanism on a first end of the body.

3. The massaging device of claim 2, further defined by a second seal that is located at the base of the securing mechanism on a second end of the body.

4. The massaging device of claim 3, wherein the first and second cap are composed of a rigid polymer.

5. The massaging device of claim 3, wherein the first and second cap are composed of rubber.

6. The massaging device of claim 3, wherein the first and second cap are composed of a metal.

7. The massaging device of claim 4, wherein the first and second cap are further defined by support members.

8. The massaging device of claim 1, wherein the securing mechanism is further defined by a female thread.

9. The massaging device of claim 1, wherein the securing mechanism is further defined by a friction fit.

10. The massaging device of claim 1, wherein the securing mechanism is further defined by a snap fit.

11. A method of massaging a muscle comprising:
obtaining a massaging device comprising a body that has a securing mechanism on at least one end, wherein the body consists of a thermal conductive material, and at least one cap that is engaged into the securing mechanism of said at least one end;
removing said cap from one end of the tubular body;
filling the tubular body with temperature variable medium;
engaging the first cap into the first end of the tubular body;
placing a muscle group on the massaging device; and,
traversing the muscle group over the massaging device.

12. The method of claim 11, wherein the temperature variable medium consists of hot medium.

13. The method of claim 11, wherein the temperature variable medium consists of a cold medium.

14. The method of claim 11, wherein the first and second cap of the massaging device are composed of a rigid polymer.

15. The method of claim 11, wherein the first and second cap of the massaging device are composed of rubber.

16. The method of claim 11, wherein the first and second cap of the massaging device are composed of a metal.

17. The method of claim 11, wherein the securing mechanism is further defined by a female thread.

18. The method of claim 11, wherein the securing mechanism is further defined by a friction fit.

19. The method of claim 11, wherein the securing mechanism is further defined by a snap fit.
